(19) United States
(12) Patent Application Publication
(10) Pub. No.: US 2004/0043091 A1
(43) Pub. Date: Mar. 4, 2004

(54) Material dispenser in an extrusion head and extrusion head using same

(76) Inventors: Joseph Schillaci, Pomy (CH); Roger Robert, Froideville (CH)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/240,381

(22) PCT Filed: Mar. 29, 2001
(86) PCT No.: PCT/CH01/00194

(30) Foreign Application Priority Data
Mar. 29, 2000 (FR) 000935

(51) Int. Cl. B29C 47/02

(52) U.S. Cl. 425/133.1

(57) ABSTRACT

An extrusion head comprising a feeding device (12) formed by at least a feeding module (14, 15, 16) and a shaping device (13). Each feeding module comprises one or several supply channels (21) of material to be extruded. The channels have a tangential material intake. The shaping device comprises at least a pair of forming rolls (22) and a support (23). The rollers are mounted so as to pivot about a central pin (24) perpendicular to the longitudinal axis (25) extruding direction. During extrusion, the support (23) and the rolls (22) rotate so as to shape the extruded cable.

### TECHNICAL DOMAIN

The present invention concerns a material dispenser in an extrusion head designed for use in an extrusion line, comprising a supply channel for the material to be extruded, a distribution channel, and a outlet nozzle for the extruded material.

It further concerns an extrusion head designed for use on an extrusion line.

### PRIOR ART

An extrusion head can be defined as a static element which permits a malleable mass of material under pressure to be transformed into a continuous, non-pressurized shape by passing it through a die. This extrudate is then cooled rapidly so that it maintains its shape and dimension. The principal operations are a connection to a pressure generator to introduce the material into the head, a material distribution zone at the core of the head, and a zone for forming the extruded object.

U.S. Pat. No. 4,499,041 can be cited as an example of a document showing the use of extrusion of multi-layer tubes.

Patent Application No. GB-A-2 134 842 can be cited as an example of a document showing the use of a shaping element.

Extrusion lines currently in use all comprise a head specifically formed of a die and a filament guide. When the line is used to extrude a synthetic material around a conductor, in particular an electrical conductor, the role of the head is to position the conductor, distribute the material around the conductor, and form the exterior of the layer or layers of synthetic material.

In order to perform these various functions, extrusion heads are designed specifically for each application. The number of layers for extrusion, the diameter of the conductor, and the diameter and physical-chemical characteristics of each of the layers all influence the shape and dimension of the head. In addition, it is complex and expensive to produce extrusion heads.

Thus, a particular, specialized extrusion head exists in conformance with the dimensions of the object for extrusion, the number of layers of synthetic material, the material constituting the extrudate, the direction of operation (from left to right or vice versa) as well as the position of the constituents of the extrusion line (vertical extruder, to the left or right of the extrusion head, or in a straight line).

Despite this apparent diversity, there are only three principal ways of distributing the material at the core of the extrusion head, as described below.

With all extrusion heads in current usage, the structure of the molecular chains of extruded material is in the direction of flow, which may be longitudinal relative to the extruded form. There is only a very slight degree of supplemental stretching.

### DESCRIPTION OF THE INVENTION

The present invention proposes overcoming the disadvantages of prior art heads and distributors by proposing an extrusion head for cables, tubes, and films comprising a pressurized flow of synthetic material in a malleable state obtained from shapes fabricated in metal elements hereinafter called modules, resulting a new molecular disposition in the realm of extruding hollow or solid cylinders or films.

This extrusion head is designed for the continuous manufacture of cylindrical tubular elements from synthetic material, such as dielectric tubes or insulators in the production of electrical cables and films.

The present invention also proposes to overcome the disadvantages of prior art heads with a modular extrusion head that allows the use of identical modules for a broad range of applications. Moreover, each of these modules is simple to manufacture.

These goals are achieved by a distributor such as the one described in the preamble, characterized in that the material intake channel is tangential to the distribution channel, said distribution channel distributing the material homogeneously around a rolling or flattening zone, and in that the distributor comprises a recentering zone directing the material towards the center of the distributor.

According to a preferred embodiment, the distributor comprises several modules, each having at least one material intake channel, one distribution channel, and one outlet nozzle.

These objectives are also achieved by an extrusion head such as the one defined above and characterized in that it comprises at least one module for suppling material for extrusion and in that it does not comprise any device for shaping the extrusion material that is integral with the supply module.

According to an advantageous embodiment, the extrusion head comprises at least one device for shaping the extrusion material, said shaping device being independent of the supply module.

According to a preferred embodiment, the extrusion head comprises several identical juxtaposed modules.

Each supply module preferably comprises a material intake channel.

When this head is used to extrude a layer of material on a cable, this material intake channel is advantageously tangential to the cable.

According to a preferred embodiment, the shaping device is placed downstream of the supply modules.

This shaping device comprises at least one pair of shaping rollers located on a support that pivots on an axle, collinear to the direction of extrusion.

According to an advantageous embodiment, the shaping rollers are symmetrically disposed relative to the axle that is collinear to the direction of extrusion.

These shaping rollers are symmetrical relative to an axle that is perpendicular to the axle, collinear to the direction of extrusion, and they pivot on this perpendicular axle.

These rollers are preferably driven in rotation by at least one motor.

The distance between the rollers in the same pair of rollers is preferably adjustable.

### BRIEF DESCRIPTION OF THE DRAWINGS

The present invention and its advantages will be better understood with reference to the different embodiments of the invention and to the attached drawings, in which:

FIGS. 1A and 1B represent the development of the path of the material around a conical or cylindrical dispenser or distributor;

FIG. 1C represents the flow of the material in a dispenser or distributor with flat elements;

FIG. 2A represents a conventional semi-compression tool;

FIGS. 2B and 2C represent tools for making tubes;

FIG. 3 is a schematic view partially in cross-section of an extrusion head according to the present invention;

FIG. 4 is a surface view of a module of the head of FIG. 1;

FIG. 5 is a profile view of a portion of the head of FIG. 1;

FIGS. 6 and 7 are perspective views of two embodiments of a detail of the extrusion head according to the present invention;

FIGS. 8A and 8B are simplified and schematic views showing the operation of a supply module according to two different variations;

FIG. 9 shows the overlapping of material entering and material that has already undergone a rotation;

FIG. 10 shows the distribution of the intake pressure around the flattening zone;

FIGS. 11A, 11B, 11C and 11D show the different shapes of the flattening zone;

FIG. 12 shows the flow of material in the distribution channel;

FIG. 13 shows the behavior of the material when flowing freely;

FIGS. 14A and 14B show the orientation of the chains and the change in the material's state;

FIGS. 15A, 15B, and 15C are non-exhaustive variations of the shapes of the passageways through which the material flows;

FIG. 16 shows a molecular chain that has undergone helicoidal deformation;

FIG. 17 represents and schematicizes the fan shape assumed by the molecular chains;

FIG. 18 shows an example of the modular application of a free extension zone;

FIG. 19 is a cross-section of the module of FIG. 18;

FIG. 20 shows an extrusion head comprising three similar modules;

FIG. 21 shows the orientation of the material intake channels in a head according to FIG. 20; and

FIG. 22 shows an extrusion head comprising three different modules.

### BEST WAYS TO ACHIEVE THE INVENTION

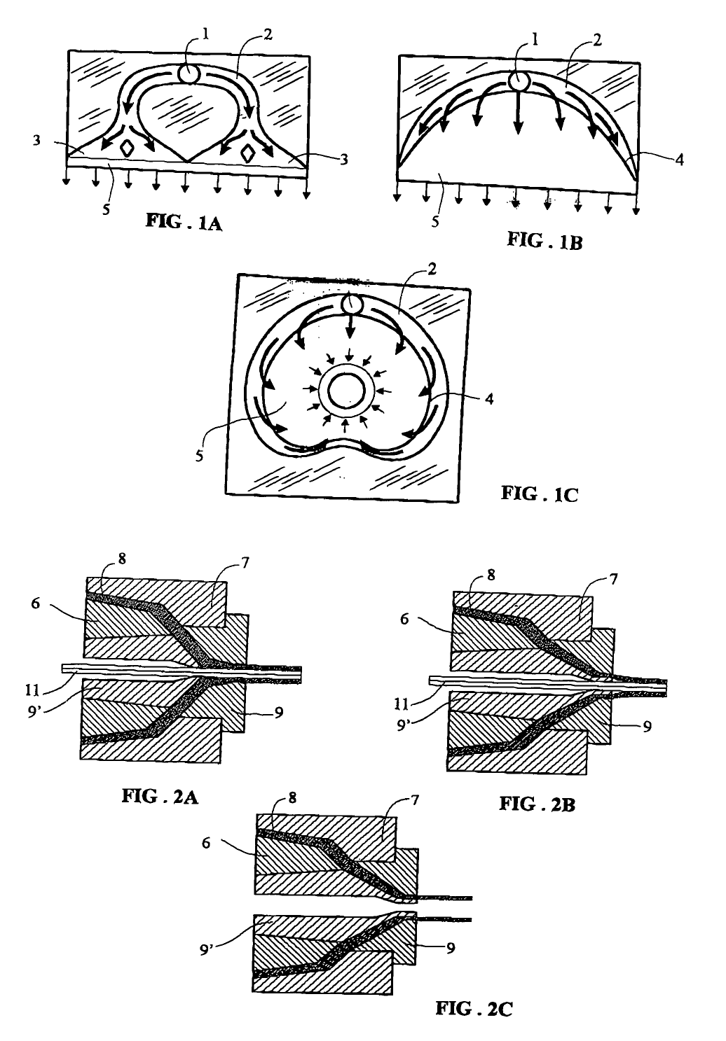

FIGS. 1A and 1B show the path the material follows around a prior art conical or cylindrical distributor. FIG. 1C shows the flow of material in a distributor consisting of flat elements.

In FIG. 1A the material enters the extrusion head through orifice 1, it is divided in principal channel 2, and then again in channels 3 to completely fill the circular section of the distributor before distribution to the shaping tools.

In FIGS. 1B and 1C the same principles are used, that is, the material enters extrusion head through orifice 1, it is divided in main channel 2 to be split near generatrix 4, completely filling zone 5 and flowing to the shaping tools.

In the area of the shaping tools we find two principal categories: the compression and semi-compression tools shown in FIG. 2A (a designation describing the angle of the final cone in the die—as the angle increases, the “compression” effect increases), and the tools for fashioning the tube represented in FIGS. 2B and 2C. Distributor 6 as well as body 7 of the extrusion head both orient and redistribute the flow of material 8 toward die 9 and filament guide 9′. Filament guide 9′ centers cable 11 and orients the material on its external surface.

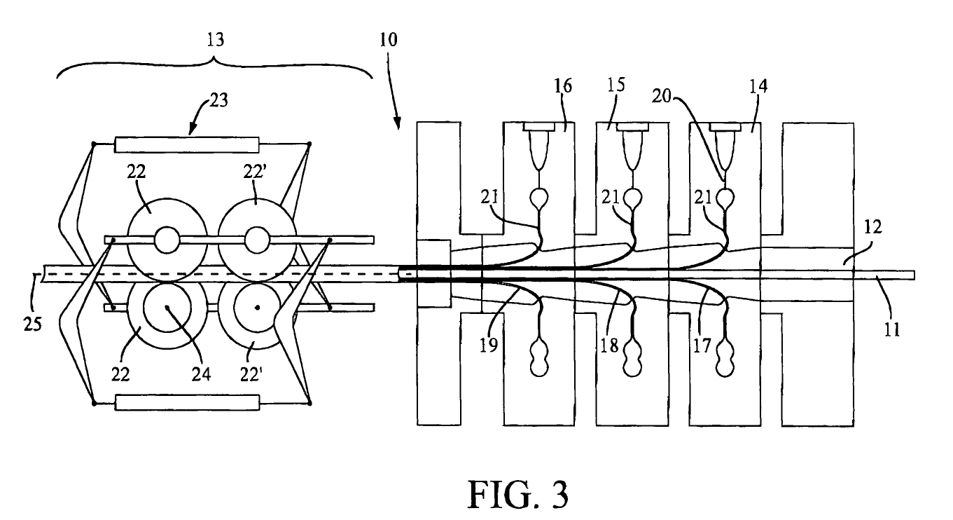

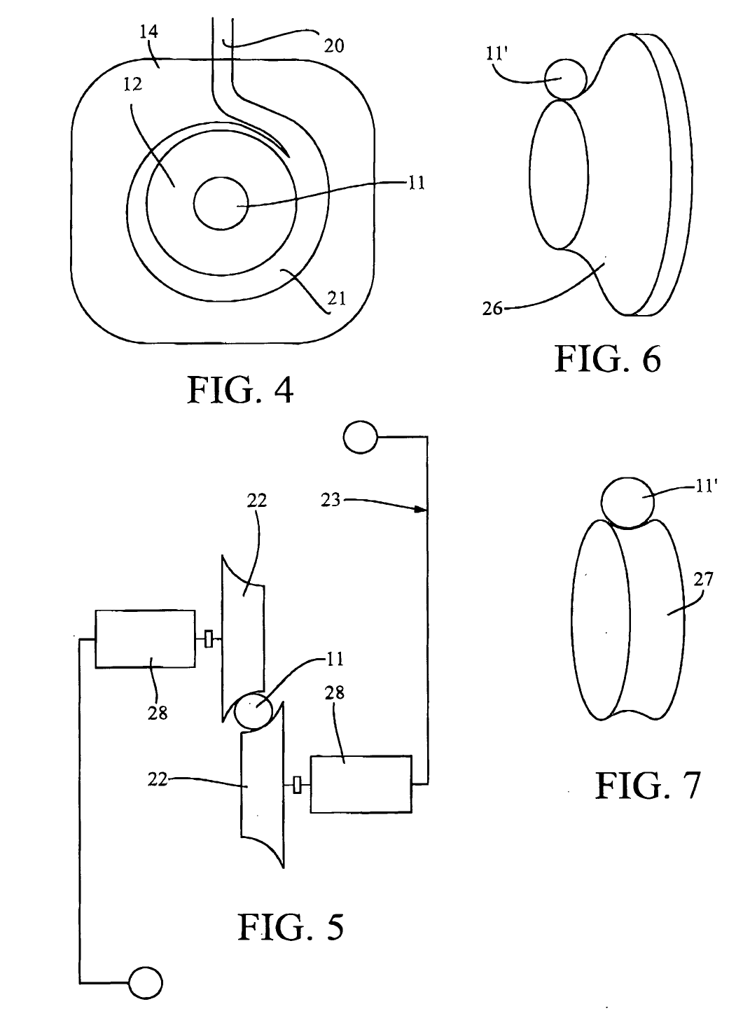

With reference to FIGS. 3 through 7, extrusion head 10 according to the present invention is illustrated in an embodiment where it is used to extrude synthetic material around a cable 11, especially an electrical conductor. This extrusion head consists of a device 13 for feeding the extrusion material, shown in detail in FIGS. 3 and 4, and a shaping device 13, shown in detail in FIGS. 3, 5, 6 and 7.

With reference to FIGS. 3 and 4, supply device 12 is formed of one or more modules 14, 15, 16, depending on the number of layers of material for extrusion.

In the example shown in FIG. 3, this device is used to extrude three layers 17, 18, 19 of material and thus it comprises three supply modules. Each of the modules comprises a passageway 20 for the cable around which the material is extruded.

Each module further comprises a material intake channel 21 shown in detail in FIG. 4. This channel is disposed around a cable passageway zone 20 and it has a tangential inlet. This channel varies in section along its circumference. This section is determined so that the thickness of the extrusion material is uniform in the finished cable. The cable passage zone also acts as the flattening zone. This flattening zone is characterized by having a narrowed passageway which increases the homogeneity of the material by causing any incompletely melted particles to circulate upstream of this zone until the appropriate structure is attained. It is advantageously formed of a circular zone, preferably with rounded angles.

In the embodiment shown in FIG. 3 the cable is introduced through the right side and leaves through the left side. This type of head is known as a right/left head. The extrusion material closest to the conductor is introduced into module 14, located at the highest upstream point. Because the incoming material flows in a tangential direction, as shown in FIG. 4, it remains essentially uniform in thickness as it spreads around the conductor.

The second layer 18 of extrusion material is introduced directly into module 15 adjacent to the module described previously and located downstream from it.

The shape of this module is identical to the preceding module so that the extrusion material is located around the cable covered with the first material extruded by the first module. The same is true for third module 16 which deposits third layer 19 of material.

Each of these modules may have an independent heating means (not shown) for adjusting the temperature to the temperature required by the specific extrusion material. This heating means may consist of a heating collar or heating pencils. The head may also be thermostatically controlled, depending upon the application.

Material is introduced into each module at a predetermined pressure. This pressure can be independently controlled for each module, in a manner well known to persons skilled in the art.

It is also possible to use modules having supply channels of varying diameters, depending upon the thickness of the extrusion layer.

This thickness essentially depends on the material used, the temperature of the module, the pressure at which material is introduced into the module, the diameter of the channel, and parameters associated with the extrusion line such as speed and flow rate of the principal roving-frame, the speed and flow rate of additional extrudates, and the speed at which the cable is pulled and unrolled.

FIGS. 3, 5, 6 and 7 show various embodiments of shaping device 13, also called a gyroscope.

The latter essentially comprises a pair of shaping rollers 22 and a support 23. In the example shown in FIGS. 3 and 5, the device comprises two pair of rollers 22, 22′ attached so that they pivot on support 23. The shaping guide rollers rotate on a central axis 24, perpendicular to longitudinal axis 25 of the extruded cable and they are symmetrical about this central axis.

The entire support 23 can also rotate on a longitudinal axle that is collinear with longitudinal cable axis 25.

FIGS. 6 and 7 show two variations of rollers 26, 27 that may be used to shape the extruded material. The shape of these rollers is selected in accordance with the diameter of the finished cable and particularly with the extruded materials.

Each roller is driven in rotation by a motor 28 or other suitable device that is either independent or controlled by a device such as a pair of rollers. The rotation speed is regulated by an electronic device allowing precise control of the motor parameters. Furthermore, the distance between two rollers in a single pair may be adjustable. The distance between the rollers in each pair can be controlled independently. For example, the farther the pair of rollers is located from the supply modules, the closer together the rollers are spaced. In this way it is possible to use the same shaping device with a broad range of cable or tube diameters.

The entire support 23 is rotated by a motor or other independent device (not shown) so that the rollers describe a helicoidal motion relative to the cable. This motion, together with the shape of the rollers, ensures that the cable is shaped correctly.

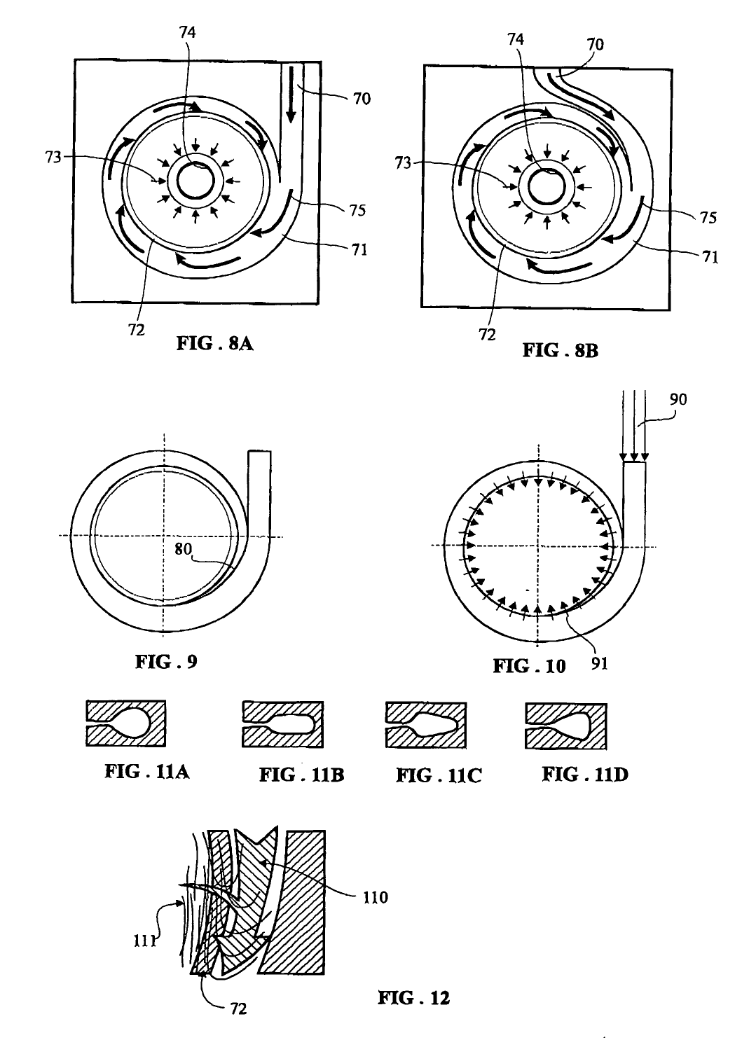

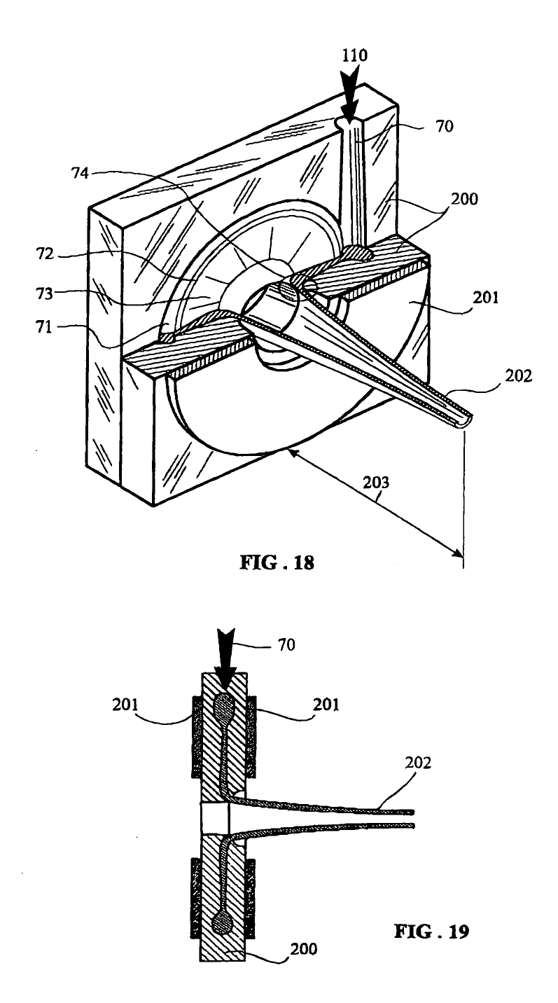

The present invention is characterized by and differentiated from prior art distributors by the features described below, with reference to the attached drawings, particularly FIGS. 8A and 8B, which are two simplified and schematic views illustrating operation of the supply module. This supply module comprises a tangential introduction conduit 70, a distribution channel 71, a flattening zone 72, a recentering zone 73, an outlet nozzle 74, and a free extension zone (see FIG. 18, reference numerals 202 and 203).

FIG. 8A represents offset, upright introduction and FIG. 8B, recentered introduction.

The shape of tangential introduction conduit 80, which is preferably cylindrical, allows the extrusion head to be connected to the extruder. Its position relative to the module may be off-center as shown in FIG. 8B, centered as shown in FIG. 8A, or some other intermediate position between these two positions. It may rotate in either a clockwise or a counterclockwise direction. Its position may vary by 360°.

Distribution channel 71 distributes the material around the circular flattening zone so that the material is distributed homogeneously. Because of its shape, the incoming material 80 and the material that has already undergone a rotation overlap, as shown in FIG. 9. Its shape must allow maximum distribution of inlet pressure 90 around the flattening zone, in the form of pressure 91 illustrated in FIG. 10. Thus, it is preferably variable in section and may possibly be changed.

It may be circular in shape (see FIG. 11A), oblong (see FIG. 11B), triangular (see FIGS. 11C and 11D), or some other shape.

Flattening zone 72 has a narrowed section, which organizes the molecular chains of the material to a very great extent.

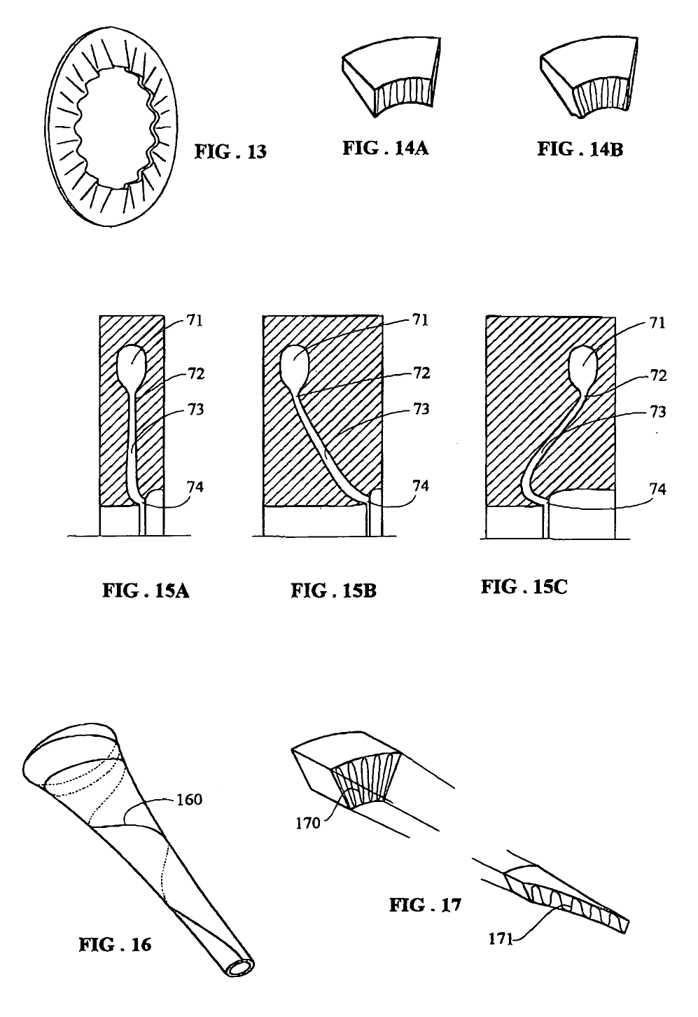

FIG. 12 shows the flow of material 110 in the distribution channel. Its passage through flattening section 72 orients chains 111. FIG. 13 is a three-dimensional schematic representation of this phenomenon. The flattening zone also improves homogeneity of the material, as explained previously.

Recentering zone 73 flows principally from physical constraints due to the geometric shapes connecting the flattening zone to the output nozzle. It allows the material to be oriented toward the center of the module with a minimum of interference with the orientation of the molecular chains.

FIG. 13 shows how the material behaves when flowing freely. FIG. 14A is a theoretical representation of the orientation of the chains if they were flowing freely, that is, without rubbing. FIG. 14B is a more realistic representation of the change undergone by the material in this zone.

To limit undesirable modifications in the structure of the material, it is necessary to limit acceleration or eliminate it by precisely sizing the shapes. This zone should be of limited length and its surface should be made as smooth as possible by some suitable treatment. Its shape is not subject to any particular restrictions and it may correspond to the shapes shown in FIGS. 15A, 15B, 15C, or any variations of these shapes.

The section of outlet nozzle 74 is the area where the material leaves the module. It will advantageously be slightly smaller in section than the section just upstream of it. Likewise, it will preferably be designed with sharp angles so the material will pass through more readily and more repetitively.

The free stretching zone shown in FIG. 18 by reference numerals 202 and 203 follows the process of shaping the material through the steps outlined above. This zone, characterized by an elongation coefficient commonly called DDR, practically non-existent in current heads, is one of the most important innovations of this invention, since it allows a multitude of products to be produced using the same configuration.

Because of the features of this invention, it is possible for the material exiting the module through the outlet nozzle to vary significantly in section. The molecular chains undergo helicoidal deformation as shown in FIG. 16 at reference number 160. For this reason, the section retains its hollow cylindrical shape and only the interior and exterior diameters vary.

FIG. 17 is a schema showing the fan shape 170 which the molecular chains acquire as they pass through the recentering zone. When it is extended, the extrudate is extended relative to the most resistant molecular bonds, that is, in the direction of the lines of chains 171. The resulting section depends upon the rate at which the material flows through the nozzle.

In FIGS. 18 and 19 an example of a modular application is shown. A complete module consists of a two part body 200 with a material inlet 110. In plates 200 forming the body, the tangential introduction conduit 70, the distribution channel 71, the lamination zone 72, the recentering zone 73, and the outlet nozzle 74 are formed.

The module may possibly be equipped with heating elements 201. Reference numeral 202 denotes the extrudate in cross-section. Reference numeral 203 denotes the stretching zone where the extrudate is freely deformed.

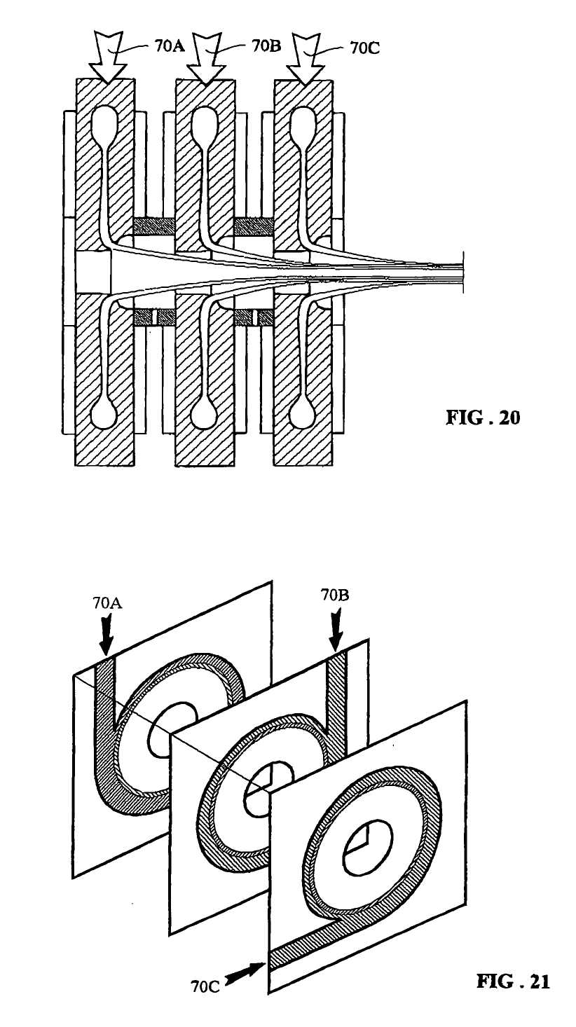

FIG. 20 shows an extrusion head comprising three similar modules, without a shaping device. Shaping is accomplished uniquely by distributing the material in the modules.

FIG. 21 represents a possible orientation for the material intake channels in the modules.

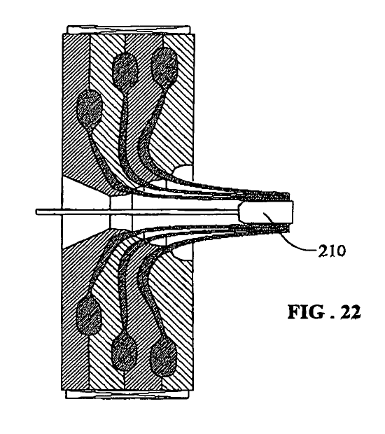

FIG. 22 is similar to FIG. 20. However, the modules are slightly different from one another, resulting in a more compact unit. In the example shown, the extrusion head is used to extrude a tube.

Depending upon the extruded product and its application, the distance between the supply modules and the shaping device may vary.

The number of rollers in the shaping device may vary, as well as their shape. The rollers may be made of any material, as may the coating and surface treatment. The rollers can have various shapes.

The number and shape of the modules may be varied. Depending upon the specific application, it is possible to use two pair of rollers, although only one embodiment using two pair of rollers has been shown. It is also possible to chill the rollers, which can increase cable extrusion speed. Each pair of rollers has been shown in the same plane. It is also possible to have several shaping devices located in different planes, for example, perpendicular to one another, or a single shaping device comprising pairs of rollers distributed along the cable periphery in a non-coplanar arrangement.

The present invention offers numerous improvements over prior art extrusion heads. The fact that the material supply operation and the shaping operation are separate allows the elements performing these operations to be independently optimized.

Additionally, the embodiment with independent modules offers a great deal of flexibility, since it is merely necessary to assemble the same number of modules as there are layers for extrusion in order to obtain the desired extrusion head.

Moreover, since each of these modules supplies the head with a single layer of materia, they are extremely simple to produce.

Insofar as the shaping device is concerned, the elements used are also simple to produce and can be very easily changed if the application requires it.

The extrusion head according to the invention has been illustrated for extruding cable comprising a central conductor. The same head could also be used for a cable containing several central elements, for a hollow tube, for padding between several conductors, for covering several insulated conductors, or for making films, etc.

This head could also be used in the food industry for extruded food products.

The rollers can also be used to give the product a particular shape, for example, a helicoidal shape with an elliptical transverse section.

The rollers may also comprise a concave or raised inscription or an ink stamp for stamping an inscription on the product.

One or more modules may comprise two or more supply channels in order to make a layer with colored striations or partially coloration. It is also possible to change material rapidly.

Note that the supply modules and the shaping device may either be separated or integrated within the same case.

The present invention is distinct from prior art devices largely by virtue of the fact that the flow of material is not divided by passing through holes or cavities. Dividing the material at this stage of extrusion is not acceptable for all synthetic materials and does not permit free stretching as the present invention does.

In the present invention, the shaping element, called the gyroscope, unlike document GB 2 134 842, uses only one principal rotational axle corresponding to the axis of the extrusion line. The gyroscope effect engendered by the rollers rotating on and around the extrudate is partially compensated for by counterweights and by the appropriate rotation speed to optimize shaping pressure.

Shaping the material for extrusion is accomplished directly using the supply module or modules.

Because of the distributor of the present invention, the extrudate is deformed and extended homogeneously, retaining its geometric shape to a far greater extent than with prior art distributors. The orientation of the lines of molecular chains forms a self-cushioning around elements without a rectilinear axis of revolution. Because of the positioning of the modules, it is possible to manufacture products with different mechanical behavior than currently existing products. Tubes of identical thickness and material are effectively more pressure-resistant and vacuum-resistant and can be more tightly coiled without deforming their cylindrical shape.

1. A distributor for material in an extrusion head designed for use on an extrusion line, comprising an intake channel for the material to be extruded, a distribution channel, and an outlet nozzle for the extruded material, characterized in that the material intake channel is tangential to the distribution channel, said distribution channel distributing the material homogeneously around a flattening zone, and in that the distributor comprises a recentering zone orienting the material toward the center of the distributor.

2. A distributor according to claim 1 characterized in that it comprises several modules, each having at least one material intake channel, one distribution channel, and one outlet nozzle.

3. An extrusion head designed for use on an extrusion line, characterized in that it comprises at least one supply module (14, 15, 16) for supplying extrusion material and in that it does not comprise any shaping device (13) for the extrusion material that is integral with the supply module.

4. An extrusion head according to claim 3 characterized in that it comprises at least one extrusion material shaping device (13), and in that the shaping device is independent of the supply module.

5. An extrusion head according to claim 3 characterized in that it comprises several identical supply modules (14, 15, 16).

6. An extrusion head according to claim 5 characterized in that the supply modules (14, 15, 16) are juxtaposed.

7. An extrusion head according to claim 3 characterized in that each supply module (14, 15, 16) comprises a material intake channel (21).

8. An extrusion head according to claim 7 designed to extrude a layer (17, 18, 19) of material on a cable (11), characterized in that the material intake channel (21) is tangential to the cable.

9. An extrusion head according to claim 4 characterized in that the shaping device (13) is located downstream of the supply modules (14, 15, 16).

10. An extrusion head according to claim 4 characterized in that the shaping device (13) comprises at least one pair of shaping rollers (22, 22′) located on a support (23) that pivots on an axle (25) collinear to the direction of extrusion.

11. An extrusion head according to claim 4 characterized in that the shaping rollers (22, 22′) are arranged symmetrically relative to the axle (25) that is collinear to the direction of extrusion.

12. An extrusion head according to claim 10 characterized in that the shaping rollers (22, 22′) are symmetrical relative to an axle (24) that is perpendicular to the axle (25) collinear to the direction of extrusion and they pivot on this perpendicular axle.

13. An extrusion head according to claim 10 characterized in that the rollers (22, 22′) are driven in rotation by at least one motor.

14. An extrusion head according to claim 10 characterized in that the distance between the rollers (22, 22′) in a single pair of rollers is adjustable.
